(19) United States
(12) Patent Application Publication
(10) Pub. No.: US 2026/0063918 A1
(43) Pub. Date: Mar. 5, 2026

(54) Light Baffles Combining Reflective and Absorption Surfaces and Imaging Systems

(71) Applicant: The Johns Hopkins University, Baltimore, MD (US)

(72) Inventors: Joseph L. Centurelli, Baltimore, MD (US); Michael A. Kelly, Bristow, VA (US); Richard L. Kenney, Columbia, MD (US); Jacob M. Greenberg, Halethorpe, MD (US); Mark J. Anderson, Columbia, MD (US); Joseph A. Miragliotta, Ellicott City, MD (US); David B. Shrekenhamer, Bethesda, MD (US); Warren Chen, Catonsville, MD (US)

(21) Appl. No.: 19/311,609

(22) Filed: Aug. 27, 2025

Related U.S. Application Data
(60) Provisional application No. 63/687,860, filed on Aug. 28, 2024.

(51) Int. Cl. G02B 27/09; G02B 5/00

(52) U.S. Cl. CPC G02B 27/0988; G02B 5/003

(57) ABSTRACT

A device for coupling with an optical device which comprises a first baffle vane and a second baffle vane. The first baffle vane comprises a first front face and a first back face, and defines a first vane opening. The second baffle vane is spaced away from the first baffle vane, comprises a second front face and a second back face, and defines a second vane opening. The first front face and the second front face each comprise a light reflecting surface, and the first back face and the second back face each comprise a light absorbing surface. The first vane opening is larger than the second vane opening, the first baffle is closer to a light entry side of the device than the second baffle, and the second baffle is closer to an imaging device side of the device than the first baffle.

### CROSS-REFERENCE TO RELATED APPLICATIONS

This application claims priority to U.S. Provisional Patent Application No. 63/687,860, filed Aug. 28, 2024, which is incorporated herein by reference in its entirety.

### STATEMENT OF GOVERNMENTAL INTEREST

This invention was made with Government support. The Government has certain rights in the invention.

### BACKGROUND

An imaging device may include a light sensor and a lens assembly having one or more lenses to focus light on the light sensor. A light baffle may be used to keep stray light away from the image sensor and the lens assembly. By minimizing the amount of stray light received by the image sensor and the lens assembly, the quality of an image produced by the imaging device may be increased.

An optical communication device may include an optical sensor and a lens assembly having one or more lenses to focus light on the optical sensor. A light baffle may be used to keep stray light away from the optical sensor and the lens assembly. By minimizing the amount of stray light received by the optical sensor and the lens assembly, the quality of a communication signal produced by the optical communication device may be increased.

An optical power transmission device may include an optical sensor and a lens assembly having one or more lenses to focus light on the optical sensor. A light baffle may be used to keep stray light away from the optical sensor and the lens assembly. By minimizing the amount of stray light received by the optical sensor and the lens assembly, the amount of power transmitted by the optical power transmission device may be increased.

### SUMMARY OF THE INVENTION

According to one aspect of the disclosure, a device for coupling with an imaging device is provided. The device can include a first baffle vane which comprises a first front face and a first back face, the first baffle vane defining a first vane opening. The device can also include a second baffle vane spaced away from the first baffle vane. The second baffle vane can comprise a second front face and a second back face, and defining a second vane opening. The first front face and the second front face can each comprise a light reflecting surface, and the first back face and the second back face can each comprise a light absorbing surface. The first vane opening can larger than the second vane opening. The first baffle can be closer to a light entry side of the device than the second baffle, and the second baffle can be closer to an imaging device side of the device than the first baffle.

According to another aspect of the disclosure, a baffle for limiting light into a field of view of an imaging device is provided. The baffle can include a plurality of baffle vanes, and each baffle vane can comprise a front face, a back face, an inner surface defining a vane opening, and an outer surface. Furthermore, each front face can comprise a light reflecting surface; each back face can comprise a light absorbing surface; each front face is parallel to each other and to each back face; each vane opening is the same shape; the vane openings decrease in size from a light entry side of the baffle to an imaging device side of the baffle; the vane openings can be aligned along an imaging axis of the baffle; and each outer surface can have the same shape and the same size. The baffle can also include a plurality of spacers. Each spacer can comprise a front face, a back face, an inner surface defining a spacer opening, and an outer surface. Furthermore, each spacer can have the same shape and the same size; each inner surface can comprise a light absorbing surface; each front face can be parallel to each other and to each back face; each front face can be disposed adjacent to the back face of one of the baffle vanes; each back face can be disposed adjacent to the front face of one of the baffle vanes; each spacer opening can have the same shape and the same size and is larger than each vane opening; the spacer openings can be aligned along the imaging axis of the baffle; and each outer surface can have the same shape and the same size as the outer surfaces of the baffle vanes.

According to one aspect of the disclosure, an imaging system is provided. The imaging system can include a light baffle and an imaging device. The light baffle can include a first baffle vane which comprises a first front face and a first back face, the first baffle vane defining a first vane opening. The device can also include a second baffle vane spaced away from the first baffle vane. The second baffle vane can comprise a second front face and a second back face, and defining a second vane opening. The first front face and the second front face can each comprise a light reflecting surface, and the first back face and the second back face can each comprise a light absorbing surface. The first vane opening can larger than the second vane opening. The first baffle can be closer to a light entry side of the device than the second baffle, and the second baffle can be closer to an imaging device side of the device than the first baffle. The imaging device can comprise a lens assembly and a light sensor. The lens assembly can comprise a front face and a back face, wherein the front face of the lens assembly faces the imaging device side of the light baffle. The light sensor can be disposed proximate the back face of the lens assembly, and the light baffle and the imaging device can be axially aligned.

### BRIEF DESCRIPTION OF THE DRAWINGS

FIGS. 1A-1B depict isometric section views of an exemplary baffle assembly according to some embodiments.

FIG. 2 depicts an isometric section view of an exemplary imaging system according to some embodiments.

FIG. 3 depicts a section view of the exemplary imaging system according to some embodiments.

FIG. 4 depicts an exploded view of an exemplary filter assembly according to some embodiments.

FIGS. 5A-5C depict reflection and/or absorption of incoming light rays by an exemplary imaging system according to some embodiments.

Various embodiments are described in detail below with reference to the accompanying drawings, wherein like reference numerals represent like elements, and wherein descriptions of like elements may not be repeated for every embodiment, but may be considered to be the same if previously described herein.

The figures provided herein are for illustrative purposes and may not be to scale. Variations in dimensions, proportions, and configurations may exist between the figures and the actual embodiments. The figures are intended to facilitate understanding of the embodiments and should not be construed as limiting the scope of the disclosure.

### DETAILED DESCRIPTION OF THE EMBODIMENTS

There are many varieties of imaging devices, each serving distinct functions and applications. Digital cameras may capture images using an electronic sensor, converting light into digital data for storage and processing. These devices may vary in resolution, sensor size, and lens configurations, allowing for diverse applications ranging from consumer photography to professional imaging. Thermal imaging devices may detect infrared radiation emitted by objects, translating it into visible images. These devices may be utilized in applications such as surveillance, firefighting, and medical diagnostics, where temperature variations are critical. X-ray imaging devices may be applied in the study of cosmic X-ray sources, such as black holes and neutron stars, capturing images of high-energy phenomena that are not visible in other wavelengths. Ultraviolet imaging devices may be employed in applications such astronomy to observe celestial phenomena that emit ultraviolet radiation, contributing to the understanding of the universe.

An imaging device may include a light sensor (or image sensor) and a lens assembly having one or more lenses to focus light on the light sensor. A light baffle may be used to keep stray light away from the light sensor and the lens assembly. By minimizing the amount of stray light received by the light sensor and the lens assembly by using a light baffle as disclosed herein, the quality of an image produced by the imaging device may be increased.

In many commercial and scientific optical systems, such as astronomical and earth observation telescopes, industrial inspection systems, and free-space optical links for communications or power beaming, unwanted radiation can enter the system via scattered light and or absorption. This light not only degrades image quality but can also introduce substantial thermal load when the incident energy is high, as in solar-illuminated scenes or high-power optical links. In applications such as optical power transfer, the excess energy can be significant, requiring large and costly thermal management systems if not properly mitigated. By using a light baffle as disclosed herein, thermal load on the optical system may be decreased.

Imaging devices may be employed in various defense applications. Digital cameras may be utilized for reconnaissance and surveillance, capturing high-resolution images of terrain and potential targets. These devices may be mounted on drones or other unmanned vehicles to provide real-time data to defense personnel. Thermal imaging devices may be used for night vision and target acquisition, detecting heat signatures of personnel and equipment in low-light or obscured environments. This capability may be critical for operations conducted under the cover of darkness or in adverse weather conditions. X-ray imaging devices may be applied in the inspection of cargo and vehicles at checkpoints, identifying concealed weapons or contraband. These devices may enhance security measures by providing detailed images of internal contents without the need for physical inspection. By using a light baffle as disclosed herein, image quality of the imaging system may be increased.

Imaging devices may be employed in various space applications. Digital cameras may be used in space exploration missions to capture high-resolution images of celestial bodies, planetary surfaces, and other astronomical phenomena. These devices may be mounted on spacecraft or satellites, providing valuable data for scientific research and analysis. Thermal imaging devices may be utilized in space missions to detect temperature variations on planetary surfaces or within spacecraft systems. This capability may be critical for monitoring thermal conditions and ensuring the proper functioning of equipment in the harsh environment of space. X-ray imaging devices may be applied in the study of cosmic X-ray sources, such as black holes and neutron stars, capturing images of high-energy phenomena that are not visible in other wavelengths. These devices may contribute to the understanding of the universe's structure and the behavior of extreme astrophysical objects. The imaging device may be integrated into space systems to enhance scientific research, operational effectiveness, and the health and safety of astronauts. One having ordinary skill in the art will understand, however, that additional power and system controls may also be used to manage the temperature of the space system or spacecraft. By using a light baffle as disclosed herein, image quality of the imaging system may be increased, and thermal load of the imaging system may be decreased.

A light baffle may be used to keep stray light away the imaging device and may include surfaces that are angled or contoured to direct unwanted light away from an optical path of the imaging device. As discovered by the inventors, by strategically positioning a light baffle as described herein proximate or within the imaging device's housing or lens assembly, the baffle may intercept and redirect light that does not contribute to image formation, thereby preventing the stray light from reaching an imaging sensor of the imaging device. The configuration of the light baffle described herein may enhance image quality by reducing glare and improving contrast, ensuring that only the desired light is captured by the imaging device. This configuration the light baffle described herein may also enhance image quality by minimizing the light-generated thermal energy within the lens assembly.

As recognized by the inventors, a light baffle that absorbs excessive thermal energy may lead to several adverse effects on the performance and functionality of the imaging system. For example, when a baffle absorbs too much light, an increase in the temperature of the baffle material may result. This temperature rise may cause thermal expansion of the baffle, potentially leading to mechanical deformation or misalignment of the baffle within the camera housing or lens assembly. Such deformation may compromise the baffle's ability to effectively block stray light, thereby reducing its efficacy in enhancing image quality. Additionally, the elevated temperature of the baffle may contribute to the generation of thermal noise within the camera system. This thermal noise may interfere with the image sensor's ability to accurately capture the desired image, resulting in a degradation of image quality, including reduced contrast and clarity.

As further recognized by the inventors, a light baffle that reflects light may encounter limitations affecting the performance and functionality of the imaging system. For example, reflective surfaces of the baffle may not completely eliminate stray light, as some light may still scatter and reach the image sensor, leading to unwanted reflections and glare. This scattering may degrade image quality by reducing contrast and clarity.

As discovered by the inventors, a light baffle that combines light absorbing qualities and light reflecting qualities may have the beneficial qualities of each but may also minimize the drawbacks of each. In this way, as discovered by the inventors, a “hybrid” baffle may maintain a low amount of stray light while also reflecting and/or absorbing away a majority of the incident energy incident beyond the field of view of the image sensor.

In some embodiments, a light baffle as disclosed herein may be part of an imaging system or an optical system, such as, for example: a camera; an imaging system for imaging light (or energy) of certain frequencies (e.g., visible light, infrared light, ultraviolet light, etc.); an X-ray imaging system; a thermal imaging system; a telescope (e.g., an astronomical observation telescope, or an earth observation telescope); an industrial inspection system; an optical communications system (e.g., a free-space optical link for communications); an optical power transfer system (e.g., a free-space optical link for power beaming); or other such system as will become apparent to one having ordinary skill in the art.

One having ordinary skill in the art will understand that optical devices besides imaging devices—for example, optical communication devices or optical power transfer devices—may also use one or more of the embodiments disclosed herein, in the same or similar manner as disclosed herein. However, for the purposes of simplicity and clarity, reference herein is generally to imaging devices.

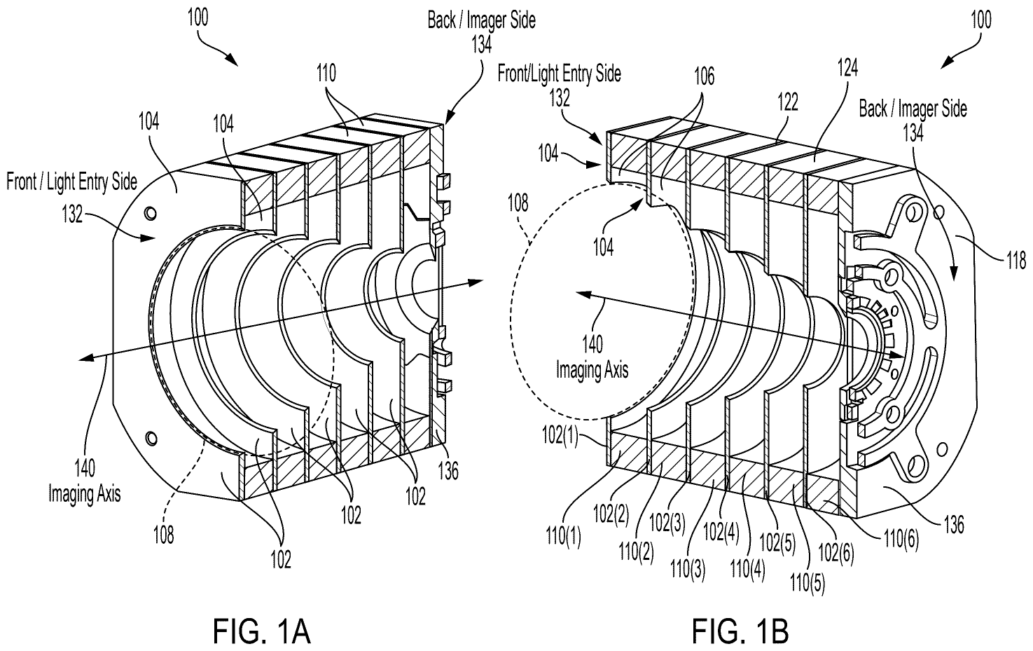

FIGS. 1A and 1B depict isometric section views of an exemplary baffle assembly 100 according to some embodiments. The isometric section views in FIGS. 1A and 1B depict a same half of baffle assembly 100, where the isometric section view in FIG. 1B depicts baffle assembly 100 rotated 90 degrees clockwise about a z-axis from the isometric section view in FIG. 1A. The other half of baffle assembly 100, which is not depicted in FIGS. 1A and 1B, is a mirror image of the half of baffle assembly 100 depicted in FIGS. 1A and 1B.

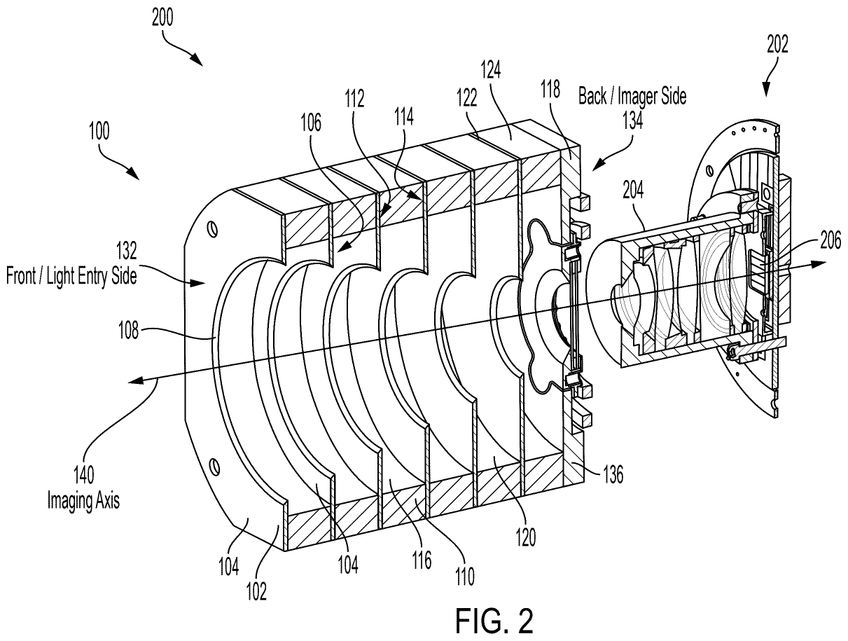

Baffle assembly 100 may be a light baffle or part of a light baffle. Baffle assembly 100 may include two opposite sides: a front or light entry side 132 and a back or imaging device side 134. The imaging device side 134 may face an imaging device, such as imaging device 202 in FIG. 2. The light entry side 132 may be the side of the baffle assembly 100 designed for light to enter baffle assembly 100, and the imaging device side 134 may be the side of baffle assembly 100 designed for light to exit baffle assembly 100. Light may enter baffle assembly 100 at the light entry side 132, pass through baffle assembly 100, and exit baffle assembly 100 at the imaging device side 134. Light exiting baffle assembly 100 at the imaging device side 134 may be imaged by an imaging device, such as imaging device 202 in FIG. 2.

Baffle assembly 100 may include a number of baffle vanes 102 which are separated from each other by spacers 110. Each baffle vane 102 may include a front face 104 which faces the light entry side 132 of the baffle assembly 100. In some embodiments, such as depicted in FIG. 1A, a front face 104 of one of the baffle vanes may also form or be part of a face of baffle assembly 100 forming the light entry side 132. Each baffle vane 102 may also include a back face 106 which faces the imaging device side 134 of the baffle assembly 100. In some embodiments, a back face 106 of one of the baffle vanes may also form or be part of a face of baffle assembly 100 forming the imaging device side 134. As depicted in FIG. 1B, a back plate 136 may form or be part of a face of baffle assembly 100 forming the imaging device side 134.

The front face 104 and back face 106 of the baffle vane 102 may be parallel. Each baffle vane 102 may also include an outer surface 122. In some embodiments, the outer surface 122 of each baffle vane 102 may be the same size and same shape. As can be seen in FIGS. 1A, 1B, and 2, the outer surface 122 may be a square with rounded corners; however, one having ordinary skill in the art will understand that any other suitable shape may be possible. As can also be seen in FIGS. 1A and 1B, some embodiments may include a plurality of baffle vanes 102. For example, one having ordinary skill in the art will understand that any number of baffle vanes, including 1, 2, 3, 4, 5, 6, 7, or more baffle vanes 102, may be included in baffle assembly 100. As depicted in FIG. 1B, baffle assembly 100 includes six baffle vanes 102, namely 102(1), 102(2), 102(3), 102(4), 102(5), and 102(6). The baffle vanes 102 may be made from any suitable material, including but not limited to, aluminum, stainless steel, titanium, polymer-based materials, carbon-reinforced polymer-based materials, or ceramic-based materials.

In some embodiments, the front face 104 of baffle vane 102 may include a light reflecting surface. As will be understood by one having ordinary skill in the art, a number of different light reflecting surfaces may be possible. In some embodiments, the light reflecting surface may be a visible light reflecting surface, an infrared light reflecting surface, an ultraviolet light reflecting surface, an X-ray reflecting surface, or a gamma ray reflecting surface. In some embodiments, the light reflecting surface may be used to reflect wavelengths of certain frequencies of energy depending on the use case of the baffle, such as for an imaging device, an optical communication device, or an optical power transmission device. In some embodiments, the light reflecting surface may be able to reflect light waves having a wavelength which is greater or equal to 3 μm and less than or equal to 5 μm. In some embodiments, the light reflecting surface may be a polished metallic coating or surface, for example and without limitation, a polished silver coating, a polished gold coating, a polished aluminum coating, or a polished rhodium coating. In some embodiments, the light reflecting surface may be a dielectric mirror coating. In some embodiments, the light reflecting surface may be a textured surface which is developed to scatter light in multiple directions, thereby reducing the intensity of any single reflection. As will be understood by one having ordinary skill in the art, such textured surfaces may include, for example and without limitation, micro-structure- or nanostructure-patterned surfaces, which may include microscopic patterns on the front face 104 of the baffle vane 102 that are designed to scatter light away from the imaging device. In some embodiments, a polymer-based reflective coating may be used.

In some embodiments, the back face 106 of the baffle vane 102 may include a light absorbing surface. In this way, light which is reflected by front face 104 of one baffle vane 102 may be absorbed by the back face 106 of another baffle vane 102 and not further reflected to the imaging device. A number of different types of light absorbing surfaces may be possible. In some embodiments, the light absorbing surface may be a visible light absorbing surface, an infrared light absorbing surface, an ultraviolet light absorbing surface, an X-ray absorbing surface, or a gamma ray absorbing surface. In some embodiments, the light absorbing surface may be used to absorb wavelengths of certain frequencies of energy depending on the use case of the baffle, such as for an imaging device, an optical communication device, or an optical power transmission device. In some embodiments, the light absorbing surface may be able to absorb light waves having a wavelength which is greater or equal to 3 μm and less than or equal to 5 μm. In some embodiments, the light-absorbing surface may include a black matte finish, which may be utilized to minimize reflections and glare by absorbing visible light. As will be understood by one having ordinary skill in the art, the matte black finish may be applied in a number of ways, including but not limited to painting, powder coating, or anodizing. In some embodiments, the light-absorbing surface may include a multi-layer dielectric coating, which may be designed to absorb specific wavelengths of light while allowing others to pass through. In some embodiments, nanostructured surfaces may be used to enhance light absorption through the manipulation of surface textures at the nanoscale, such as carbon nanotubes.

Each baffle vane 102 may also include a vane opening 108 through which light traveling from the light entry side 132 of the baffle assembly 100 may pass so it may ultimately reach the imaging device. Each vane opening 108 may have a circular shape. However, due to the isometric view in FIGS. 1A and 1B, the vane openings 108 are not depicted as circular. If baffle assembly 100 were viewed perpendicular to the front side 132, each vane opening 108 would appear circular. In some embodiments, each vane opening 108 may have the same shape. However, one having ordinary skill in the art will understand that other vane opening 108 shapes besides circular may be possible. As can also be seen in FIGS. 1A and 1B, each vane opening 108 may have a different size. For example, in some embodiments, the size of the vane openings 108 may decrease as the respective vane baffles 102 get closer to the imaging device side 134 of the baffle assembly 100. In other words, a first baffle vane 102 (1) which is closest to the light entry side 132 of the baffle assembly 100 may have the largest vane opening 108; a second baffle vane 102 (2) which is closer to the imaging device side 134 than the first baffle vane 102 (1) may have a vane opening 108 which is smaller than the vane opening 108 of the first baffle vane 102 (1); a third baffle vane 102 (3) which is closer to the imaging device side 134 than the second baffle vane 102 (2) may have a vane opening 108 which is smaller than the vane opening 108 of the second baffle vane 102 (2); and so on. The vane openings 108 may be any suitable shape. For example, the vane openings 108 may have a circular shape or a polygonal shape. In some embodiments, in the case of circular vane openings 108, the vane openings 108 may define a combined conical-shaped opening for the baffle assembly 100 because they proportionally decrease in size from the light entry side 132 to the imaging device side 134 along an imaging axis 140, which will be defined in further detail below.

The vane openings 108 may be any suitable size. For example, in some embodiments, the smallest vane opening 108 (i.e., the vane opening 108 of the baffle vane 102 which is closest to the imaging device side 134 of baffle assembly 100 (e.g., baffle vane 102 (6) in FIG. 1B)) may be a circle having a radius of approximately 1 mm, 5, mm, 10 mm, 50 mm, 100 mm, or any size therein, or any other suitable size. In some embodiments, the largest vane opening 108 (i.e., the vane opening 108 of the baffle vane 102 which is closest to the light entry side 132 of baffle assembly 100 (e.g., baffle vane 102 (1) in FIG. 1B)) may be a circle having a radius of approximately 30 mm, 35 mm, 50 mm, 100 mm, 150 mm, or any size therein, or any other suitable size. In some embodiments, the smallest vane opening 108 may be a circle having a radius of greater than or equal to 6 mm, and the largest vane opening 108 may be a circle having a radius of less than or equal to 30 mm.

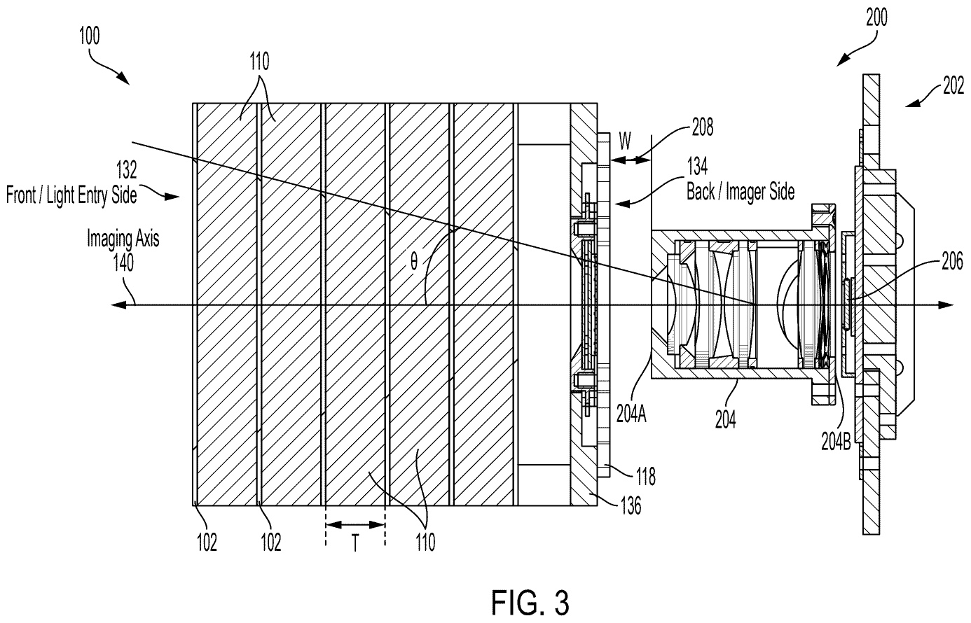

Each of the vane openings 108 may be aligned along an imaging axis 140, which is shown in each of FIGS. 1A-5C. In baffle assembly 100, in which each of the vane openings 108 is circular, the imaging axis 140 may run through the centers of each vane opening 108. In this way, each of the baffle vanes 108 may be aligned along the imaging axis 140. Furthermore, the front face 104 of the baffle vane 102 (1), which is closest to the light entry side, may define a first plane such that imaging axis defines a second plane which is perpendicular to the first plane. As discussed above, the vane openings 108 may decrease in size along the imaging axis 140 to form a conical opening of baffle assembly 100. In this way, when viewed in cross-section (as seen in FIG. 3, which only depicts the interior of baffle assembly 100), the vane openings 108 may form an angle θ in the second plane with respect to the imaging axis. One having ordinary skill in the art will understand that angle θ may be any suitable size. For example, in some embodiments, angle θ may be 1 degree, 5 degrees, 10 degrees, 15 degrees, 30 degrees, 50 degrees, 75 degrees, or any angle therein, or any other angle.

On the other hand, in some embodiments, the vane openings 108 of the respective baffle vanes 102 may all be the same size.

Referring now to FIGS. 1A, 1B, and 2, baffle assembly 100 may also include one or more spacers 110. As depicted in FIG. 1B, baffle assembly 100 includes six spacers 110, namely 110(1), 110(2), 110(3), 110(4), 110(5), and 110(6). In some embodiments, the spacers 110 may be positioned between adjacent baffle vanes 102. In this way, the number of spacers 110 included in baffle assembly 100 may be dictated by the number of baffle vanes 102 in baffle assembly 100. For example, some embodiments may include two baffle vanes 102 with a single spacer 110 positioned therebetween; some embodiments may include three baffle vanes 102 with a first spacer 110 positioned between the first and second baffle vanes 102, and a second spacer positioned between the second and third baffle vanes 102; and so on. For example, as depicted in FIG. 1B, the first spacer 110(1) is positioned between the first baffle vane 102(1) and the second baffle vane 102(2), the second spacer 110(2) is positioned between the second baffle vane 102(2) and the third baffle vane 102(3), and so on. In some embodiments, the number of baffle vanes 102 and the number of spacers 110 may be the same. For example, as depicted in FIGS. 1A and 1B, baffle assembly 100 includes six baffle vanes 102 and six spacers 110. In some embodiments, the number of baffle vanes 102 may be more than the number of spacers 110. In some embodiments, the number of baffle vanes 102 may be less than the number of spacers 110.

As depicted in FIG. 2, each spacer 110 may include a front face 112 which faces the light entry side 132 of baffle assembly 100 and a back face 114 which faces the imaging device side 134 of baffle assembly 100. The spacer 110 may also include an inner face 116. Inner face 116 may define a spacer opening 120. As can be seen in FIGS. 1A, 1B, and 2, spacer opening 120 may be larger than any of the vane openings 108. In some embodiments, the spacer openings 120 may have a same shape as the vane openings 108. For example, as can be seen in FIGS. 1A, 1B, and 2, the spacer openings 120 have a circular shape, similar to the vane openings 108. In some embodiments, the spacer openings 120 may have a different shape than the vane openings 108. In some embodiments, each spacer 110 may be sandwiched between respective adjacent baffle vanes 102 such that, when assembled, the front and back faces 112, 114 of the spacer 110 are not visible. In some embodiments, the inner face 116 of the spacer 110 may have the same light absorbing surface and qualities as the back face 106 of the baffle vanes 102. Like the baffle vanes 102, the spacers 110 may also be aligned along the imaging axis 140.

Each spacer 110 may also include an outer surface 124. In some embodiments, the outer surface 124 of each spacer 110 may be the same size and same shape. As can be seen in FIGS. 1A, 1B, and 2, the outer surface 124 may be a square with rounded corners; however, one having ordinary skill in the art will understand that any other suitable shape for the outer surface 124 may be possible. Furthermore, in some embodiments, the size and shape of the outer surface 124 of the spacer 110 may be the same size and shape as the outer surface 122 of the baffle vanes 102.

The spacers 110 may be made from any suitable material, including but not limited to, aluminum, stainless steel, titanium, polymer-based materials, carbon-reinforced polymer-based materials, or ceramic-based materials. In some embodiments, the spacer 110 may have a thickness (or depth along the imaging axis 140) T (as depicted in FIG. 3, which only depicts the interior of baffle assembly 100) of approximately 0.5 inches, however, any other thickness may be possible. For example, the spacer 110 may be greater than or equal to 0.125 inches thick and less than 1 inch thick. The thickness of spacer 110 may be 1 mm, 10 mm, 100 mm, 200 mm, 300 mm, 400 mm, 500 mm, 1,000 mm, 5,000 mm, 10,000 mm, or any size therein, or any other size.

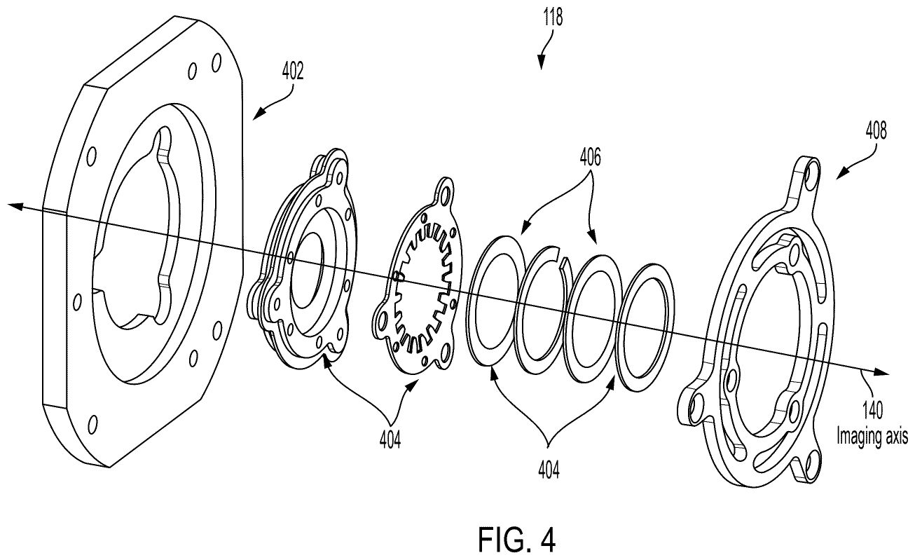

FIG. 4 depicts an exploded view of an exemplary filter assembly 118 according to some embodiments. In some embodiments, baffle assembly 100 may also include a filter assembly 118 positioned on the imaging device side of the assembly 100. In some embodiments, filter assembly may form or be part of back plate 136. As shown in greater detail in FIG. 4, filter assembly 118 may include baffle interface 402, a number of retention brackets 404, a number of optical filters 406 which are positioned in an alternating manner with retention brackets 404, and a thermal isolator 408. Baffle interface 402 may serve both as a bracket to secure the other components of filter assembly 118 to the rest of the baffle assembly 100 and, optionally, as a final baffle vane 102. Retention brackets 404 may serve to secure the optical filters 406 to the baffle interface 402. Thermal isolator 408 may serve as a heat sink to absorb any thermal energy which has not already been absorbed by the various baffle vanes 102 and spacers 110.

FIG. 2 depicts an isometric section view of an exemplary imaging system 200 according to some embodiments, and FIG. 3 depicts a section view of the exemplary imaging system 200 according to some embodiments. In particular, FIG. 3 only depicts the interior of baffle assembly 100. The imaging system 200 includes baffle assembly 100 and imaging device 202. Imaging device 202 may be any type of suitable imaging device, as will be understood by one having ordinary skill in the art. For example, imaging device 202 may capture digital images and/or analog images. For example, imaging device 202 may capture visible light images, thermal images, X-ray images, and/or ultraviolet images, such as discussed herein. For example, imaging device 202 may capture mid-wave infrared (MWIR) images and/or long-wave infrared (LWIR) images. For example, imaging device 202 may capture images for use in ultraviolet-visible (UV-Vis) spectroscopy. For example, imaging device 202 may have a narrow field of view (e.g., a telescopic field), a wide field of view, or any field of view therein, or any field of view.

Imaging device 202 may include a lens assembly 204 and a light sensor (or image sensor) 206. Lens assembly 204 may include a front face 204A and a back face 204B, wherein front face 204A faces the imaging device side 134 of baffle assembly 100 and back face 204B faces the light sensor 206. As seen in FIGS. 2 and 3, the imaging device 202 and its components (e.g., lens assembly 204 and light sensor 206) may all be axially aligned with the imaging axis 140 and thus axially aligned with the baffle assembly 100.

To promote image quality, the imaging device 202 may be thermally isolated from the baffle assembly 100. As shown in FIG. 3, to promote thermal isolation of the light sensor 206, the imaging system 200 may also include an air gap 208 between the baffle assembly 100 and the imaging device. In some embodiments, the air gap 208 between the back plate 136 of baffle assembly 100 and the front face 204A of the lens assembly 200. The air gap 208 may be any suitable size to promote thermal isolation. In some embodiments, the air gap 208 may have a distance or width W (or depth along the imaging axis 140) of 0.5 inch. In some embodiments, the width W of the air gap 208 may be 0.001 inch, 0.01 inch, 0.1 inch, 0.125 inch, 0.25 inch, 0.625 inch, 0.75 inch, 0.875 inch, 1 inch, 2 inches, 5 inches, or any size therein, or more.

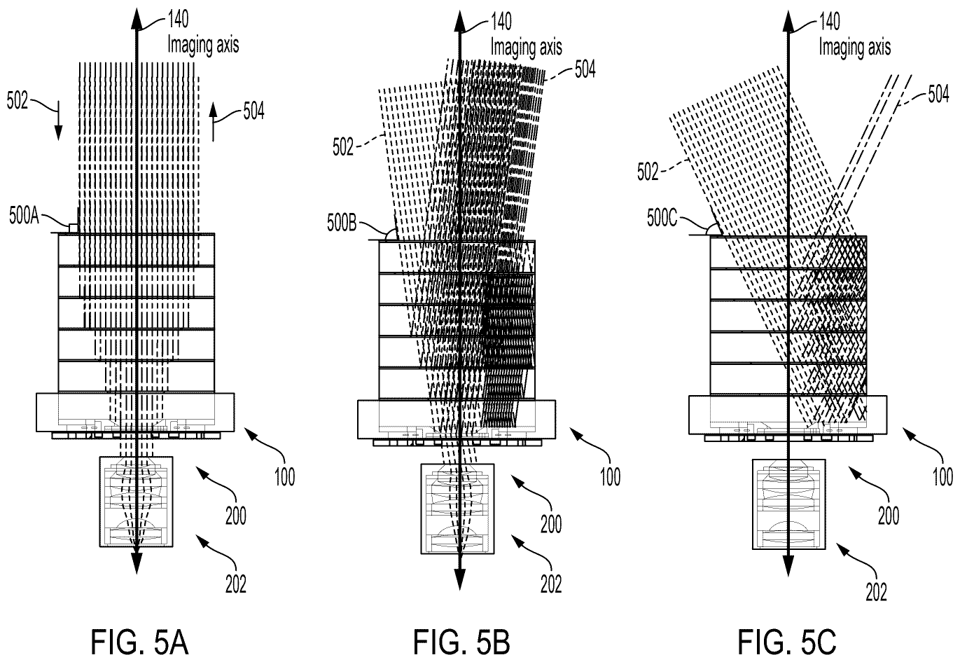

FIGS. 5A-5C depict a functionality of the exemplary imaging system 200 and, in particular, depict reflection and/or absorption of incoming light rays by the exemplary imaging system 200 according to some embodiments. For example, FIGS. 5A-5C depict how incoming light rays 502 may be reflected and/or absorbed by baffle assembly 100, or received by imaging device 202.

In FIG. 5A, incoming light rays 502 approach imaging system 200 at an angle 500A, which is approximately 90 degrees relative to the front face 104 of the baffle vanes 102. As can be seen, the light rays 502 which are clustered closest to the imaging axis are able to pass through the smallest vane opening 108 (i.e., the vane opening 108 closest to the imaging device side 134 of the baffle assembly 100), whereas the rest of the light rays 504 are reflected away from the imaging device 200.

In FIG. 5B, incoming light rays 502 approach imaging system 200 at an angle 500B, which is approximately 75 degrees relative to the front face 104 of the baffle vanes 102. As can be seen, the light rays 502 which are clustered furthest to the left of the imaging axis are able to pass through the smallest vane opening 108 (i.e., the vane opening 108 closest to the imaging device side 134 of the baffle assembly 100) and into the imaging device 202, whereas the rest of the light rays 504 are either reflected away from the imaging device 202 by the front faces 104 of the various baffle vanes 102, or absorbed by the back faces 106 of the various baffle vanes 102, or absorbed by the inner surfaces 116 of the spacers 110.

In FIG. 5C, incoming light rays 502 approach imaging system 200 at an angle 500C, which is approximately 45 degrees relative to the front face 104 of the baffle vanes 102. As can be seen, none of the light rays 502 are able to pass through the smallest vane opening 108 (i.e., the vane opening 108 closest to the imaging device side 132 of the baffle assembly 100) and into the imaging device 202. Instead, all of the light rays 504 are either reflected away from the imaging device 202 by the front faces 104 of the various baffle vanes 102, or absorbed by the back faces 106 of the various baffle vanes 102, or absorbed by the inner surfaces 116 of the spacers 110.

Although FIGS. 5A, 5B, and 5C depict incoming light rays 502 at angles of approximately 90 degrees, 75 degrees, and 45 degrees, respectively, one having ordinary skill in the art will understand incoming light rays 502 may have any angle. To that end, in some embodiments the size of baffle assembly 100 may be adjusted to better reflect or absorb incoming light rays 502. In particular, in some embodiments, the diameter of vane opening 108 may be increased or decreased accordingly. Additionally or alternatively, the length of baffle assembly 100 (i.e., the dimension of baffle assembly 100 in the direction of the imaging axis 140) may be increased or decreased accordingly.

### Illustrative Embodiments

The invention includes other illustrative embodiments (“Embodiments”) as follows.
Embodiment 1. A device for coupling with an optical device, the device comprising: a first baffle vane comprising a first front face and a first back face, the first baffle vane defining a first vane opening; and a second baffle vane spaced away from the first baffle vane, the second baffle vane comprising a second front face and a second back face, and defining a second vane opening, wherein the first front face and the second front face each comprise a light reflecting surface, wherein the first back face and the second back face each comprise a light absorbing surface, wherein the first vane opening is larger than the second vane opening, wherein the first baffle is closer to a light entry side of the device than the second baffle, and wherein the second baffle is closer to an imaging device side of the device than the first baffle.
Embodiment 2. The device of embodiment 1, further comprising: a first spacer comprising a first front face, a first back face, and a first inner face, wherein the first inner face of the first spacer comprises a light absorbing surface, wherein the first front face of the first spacer is disposed adjacent the first back face of the first baffle vane, wherein the first back face of the first spacer is disposed adjacent the second front face of the second baffle vane, wherein the first spacer defines a first spacer opening larger than the first vane opening and the second vane opening,
Embodiment 3. The device of embodiment 2, wherein the first vane opening, the second vane opening, and the spacer opening are aligned along an imaging axis of the device.
Embodiment 3A. The device of embodiment 2, wherein the spacer comprises a thickness which is greater than or equal to 0.125 inches and less than or equal to 1 inch.
Embodiment 3B. The device of embodiment 1, wherein a distance between the first back face of the first baffle vein and the second front face of the second baffle vein is greater than or equal to 0.125 inches and less than or equal to 1 inch.
Embodiment 4. The device of embodiment 1, wherein each of the light reflecting surfaces comprise a polished metallic coating.
Embodiment 5. The device of embodiment 1, wherein each of the light absorbing surfaces comprise an infrared-absorbing coating or a visible light-absorbing coating.
Embodiment 6. The device of embodiment 1, wherein each of the light reflecting surfaces is configured to reflect at least one of visible light or infrared light, and wherein each of the light absorbing surfaces is configured to absorb at least one of visible light or infrared light.
Embodiment 6B. The device of embodiment 1, wherein each of the light reflecting surfaces is configured to reflect visible light and each of the light absorbing surfaces is configured to absorb visible light.
Embodiment 7. The device of embodiment 1, further comprising a filter assembly comprising at least one optical filter, the filter assembly connected to the imaging device side of the device.
Embodiment 8. The device of embodiment 7, wherein the filter assembly further comprises a thermal isolator.
Embodiment 9. The device of embodiment 1, wherein the first front face of the first baffle vane defines a first plane which coincides with the first front face, and a second plane which is perpendicular to the first plane the first vane opening and the second vane opening are aligned along an imaging axis of the device, wherein the imaging axis is located on the second plane; and the first vane opening and the second vane opening define an angle greater than or equal to 5 degrees and less than or equal to 25 degrees relative to the imaging axis.
Embodiment 9A. The device of embodiment 1, wherein when viewed from a direction which is perpendicular to the first front face of the first baffle vane, the first vane opening and second vane opening each define a circle comprising a radius; and the radius of the first vane opening and the second vane opening are each greater than or equal to 6 mm and less than or equal to 30 mm.
Embodiment 10. A baffle for limiting light into a field of view of an optical device, comprising: a plurality of baffle vanes, each baffle vane comprising a front face, a back face, an inner surface defining a vane opening, and an outer surface, wherein: each front face comprises a light reflecting surface, each back face comprises a light absorbing surface, each front face is parallel to each other and to each back face, each vane opening has a same shape, the vane openings decrease in size from a light entry side of the baffle to an imaging device side of the baffle, the vane openings are aligned along an imaging axis of the baffle, and each outer surface has a same shape and a same size; and a plurality of spacers, each spacer comprising a front face, a back face, an inner surface defining a spacer opening, and an outer surface, wherein: each spacer has a same shape and a same size, each inner surface comprises a light absorbing surface, each front face is parallel to each other and to each back face, each front face is disposed adjacent to the back face of one of the baffle vanes, each back face is disposed adjacent to the front face of one of the baffle vanes, each spacer opening has a same shape and a same size and is larger than each vane opening, the spacer openings are aligned along the imaging axis of the baffle, and each outer surface has the same shape and the same size as the outer surfaces of the baffle vanes.
Embodiment 11. The baffle of embodiment 10, wherein each of the light reflecting surfaces comprise a polished metallic coating.
Embodiment 12. The baffle of embodiment 10, wherein each of the light absorbing surfaces comprise an infrared-absorbing coating or a visible light-absorbing coating.
Embodiment 13. The baffle of embodiment 10, wherein each of the light reflecting surfaces of the baffle vanes are configured to reflect at least one of visible light or infrared light, and wherein each of the light absorbing surfaces of the baffle vanes and the spacers are configured to absorb at least one of visible light or infrared light.
Embodiment 13A. The baffle of embodiment 10, wherein each of the light reflecting surfaces of the baffle vanes are configured to reflect light comprising a wavelength; each of the light absorbing surfaces of the baffle vanes and the spacers are configured to absorb light comprising the wavelength; and the wavelength is greater or equal to 3 μm and less than or equal to 5 μm.
Embodiment 13B. The baffle of embodiment 10, wherein each of the light reflecting surfaces of the baffle vanes are configured to reflect visible light; and each of the light absorbing surfaces of the baffle vanes and the spacers are configured to absorb visible light.
Embodiment 14. The baffle of embodiment 10, further comprising a filter assembly comprising at least one optical filter, the filter assembly connected to the imaging device side of the device.
Embodiment 15. The baffle of embodiment 14, wherein the filter assembly further comprises a thermal isolator.
Embodiment 16. The baffle of embodiment 10, wherein the first vane opening and the second vane opening define an angle greater than or equal to 5 degrees and less than or equal to 25 degrees relative to the imaging axis.
Embodiment 17. An optical system comprising: a light baffle comprising: a first baffle vane comprising a first front face and a first back face, the first baffle vane defining a first baffle opening; and a second baffle vane spaced away from the first baffle vane, the second baffle vane comprising a second front face and a second back face, and defining a second baffle opening; wherein the first front face and the second front face each comprise a light reflecting surface, wherein the first back face and the second back face each comprise a light absorbing surface, wherein the first baffle opening is larger than the second baffle opening, wherein the first baffle is closer to a light entry side of the light baffle than the second baffle, and wherein the second baffle is closer to an imaging device side of the light baffle than the first baffle; and an optical device comprising: a lens assembly comprising a front face and a back face, the front face of the lens assembly facing the imaging device side of the light baffle; and a light sensor disposed proximate the back face of the lens assembly; wherein the light baffle and the imaging device are axially aligned.
Embodiment 18. The optical system of embodiment 17, wherein the light baffle further comprises a thermal isolator disposed at, on, or as part of a back face of the light baffle, wherein the thermal isolator is disposed between the second baffle vane and the optical device along an imaging axis of the optical system.
Embodiment 19. The optical system of embodiment 17, wherein the optical device is thermally isolated from the light baffle.
Embodiment 20. The optical system of embodiment 19, further comprising an air gap disposed between the light baffle and the optical device.
Embodiment 20A. The optical system of embodiment 20, wherein the air gap comprises a width which is greater than or equal to 0.125 inches and less than or equal to 1 inch.
Embodiment 21. The optical system of claim 17, wherein the optical system is one of a camera, an imaging system for imaging visible light, infrared light, and/or ultraviolet light, an X-ray imaging system, a thermal imaging system, a telescope, an industrial inspection system, an optical communications system, or an optical power transfer system.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

Numerous modifications, alterations, and changes to the described embodiments are possible without departing from the scope of the present invention defined in the claims. It is intended that the present invention need not be limited to the described embodiments, but that it has the full scope defined by the language of the following claims, and equivalents thereof.

What is claimed is:

1. A device for coupling with an optical device, the device comprising:
a first baffle vane comprising a first front face and a first back face, the first baffle vane defining a first vane opening; and
a second baffle vane spaced away from the first baffle vane, the second baffle vane comprising a second front face and a second back face, and defining a second vane opening,
wherein the first front face and the second front face each comprise a light reflecting surface,
wherein the first back face and the second back face each comprise a light absorbing surface,
wherein the first vane opening is larger than the second vane opening,
wherein the first baffle is closer to a light entry side of the device than the second baffle, and
wherein the second baffle is closer to an imaging device side of the device than the first baffle.

2. The device of claim 1, further comprising:
a first spacer comprising a first front face, a first back face, and a first inner face,
wherein the first inner face of the first spacer comprises a light absorbing surface,
wherein the first front face of the first spacer is disposed adjacent the first back face of the first baffle vane,
wherein the first back face of the first spacer is disposed adjacent the second front face of the second baffle vane,
wherein the first spacer defines a first spacer opening larger than the first vane opening and the second vane opening.

3. The device of claim 2, wherein the first vane opening, the second vane opening, and the spacer opening are aligned along an imaging axis of the device.

4. The device of claim 1, wherein each of the light reflecting surfaces comprise a polished metallic coating.

5. The device of claim 1, wherein each of the light absorbing surfaces comprise an infrared-absorbing coating or a visible light-absorbing coating.

6. The device of claim 1, wherein each of the light reflecting surfaces is configured to reflect at least one of visible light or infrared light, and
wherein each of the light absorbing surfaces is configured to absorb at least one of visible light or infrared light.

7. The device of claim 1, further comprising a filter assembly comprising at least one optical filter, the filter assembly connected to the imaging device side of the device.

8. The device of claim 7, wherein the filter assembly further comprises a thermal isolator.

9. The device of claim 1, wherein
the first front face of the first baffle vane defines a first plane which coincides with the first front face, and a second plane which is perpendicular to the first plane
the first vane opening and the second vane opening are aligned along an imaging axis of the device, wherein the imaging axis is located on the second plane; and
the first vane opening and the second vane opening define an angle greater than or equal to 5 degrees and less than or equal to 25 degrees relative to the imaging axis.

10. A baffle for limiting light into a field of view of an optical device, comprising:
a plurality of baffle vanes, each baffle vane comprising a front face, a back face, an inner surface defining a vane opening, and an outer surface, wherein:
each front face comprises a light reflecting surface,
each back face comprises a light absorbing surface,
each front face is parallel to each other and to each back face,
each vane opening has a same shape,
the vane openings decrease in size from a light entry side of the baffle to an imaging device side of the baffle,
the vane openings are aligned along an imaging axis of the baffle, and
each outer surface has a same shape and a same size; and
a plurality of spacers, each spacer comprising a front face, a back face, an inner surface defining a spacer opening, and an outer surface, wherein:
each spacer has a same shape and a same size,
each inner surface comprises a light absorbing surface,
each front face is parallel to each other and to each back face,
each front face is disposed adjacent to the back face of one of the baffle vanes,
each back face is disposed adjacent to the front face of one of the baffle vanes,
each spacer opening has a same shape and a same size and is larger than each vane opening,
the spacer openings are aligned along the imaging axis of the baffle, and
each outer surface has the same shape and the same size as the outer surfaces of the baffle vanes.

11. The baffle of claim 10, wherein each of the light reflecting surfaces comprise a polished metallic coating.

12. The baffle of claim 10, wherein each of the light absorbing surfaces comprise an infrared-absorbing coating or a visible light-absorbing coating.

13. The baffle of claim 10, wherein each of the light reflecting surfaces of the baffle vanes are configured to reflect at least one of visible light or infrared light, and
wherein each of the light absorbing surfaces of the baffle vanes and the spacers are configured to absorb at least one of visible light or infrared light.

14. The baffle of claim 10, further comprising a filter assembly comprising at least one optical filter, the filter assembly connected to the imaging device side of the device.

15. The baffle of claim 14, wherein the filter assembly further comprises a thermal isolator.

16. The baffle of claim 10, wherein a first vane opening and a second vane opening define an angle greater than or equal to 5 degrees and less than or equal to 25 degrees relative to the imaging axis.

17. An optical system comprising:
a light baffle comprising:
a first baffle vane comprising a first front face and a first back face, the first baffle vane defining a first baffle opening; and
a second baffle vane spaced away from the first baffle vane, the second baffle vane comprising a second front face and a second back face, and defining a second baffle opening;
wherein the first front face and the second front face each comprise a light reflecting surface,
wherein the first back face and the second back face each comprise a light absorbing surface,
wherein the first baffle opening is larger than the second baffle opening,
wherein the first baffle is closer to a light entry side of the light baffle than the second baffle, and
wherein the second baffle is closer to an imaging device side of the light baffle than the first baffle; and
an optical device comprising:
a lens assembly comprising a front face and a back face, the front face of the lens assembly facing the imaging device side of the light baffle; and
a light sensor disposed proximate the back face of the lens assembly;
wherein the light baffle and the imaging device are axially aligned.

18. The optical system of claim 17, wherein the light baffle further comprises a thermal isolator disposed at, on, or as part of a back face of the light baffle, wherein the thermal isolator is disposed between the second baffle vane and the optical device along an imaging axis of the optical system.

19. The optical system of claim 17, wherein the optical device is thermally isolated from the light baffle.

20. The optical system of claim 19, further comprising an air gap disposed between the light baffle and the optical device.
